(19) United States
(12) Patent Application Publication
(10) Pub. No.: US 2008/0098087 A1
(43) Pub. Date: Apr. 24, 2008

(54) INTEGRATED ELECTRONIC INVITATION PROCESS

(75) Inventor: Susan Lubeck, San Francisco, CA (US)

Correspondence Address: SCHWEGMAN, LUNDBERG & WOESSNER, P.A., P.O. BOX 2938, MINNEAPOLIS, MN, 55402, US

(73) Assignee: FabFemme Inc.

(21) Appl. No.: 11/552,297

(22) Filed: Oct. 24, 2006

(51) Int. Cl. G06F 15/16

(52) U.S. Cl. 709/218

(57) ABSTRACT

A method and system to generate an electronic invitation are provided. The system may include a display module, a communications module and an invitation engine. The display module may be configured to display an invite control viewable with a member profile section. The member profile section may display a profile of a member. The communications module may be configured to receive a request to activate the invite control. The invitation engine may be configured to react to the request by adding an identification of the member to an invitee list.

### TECHNICAL FIELD

This application relates to a method and system to generate an electronic invitation.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Online social networking may allow individuals to utilize their personal network of friends, acquaintances, and colleagues to make new contacts and to find relevant connections for dating, professional networking, service referrals, leisure activities, and otherwise participate in building online communities. The benefits of multiple-interest groups of users have been translated into advantageous business models. Some online services offer websites for digital image sharing and management, online merchant systems utilizing collaborative filtering, systems that facilitate online and real-world social activities, as well as dating websites that attempt to match individuals to one another using a number of different techniques.

Separate from an online social network service, there may exist a website that allows users to create and send electronic invitations. Such a website may provide a user interface to allow an organizer of an event to create an electronic invitation and to distribute it to invitees.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example embodiment may be implemented;

FIG. 2 a block diagram of a system to generate an electronic invitation, in accordance with an example embodiment;

FIG. 3 is a flow chart of a method to generate an electronic invitation, in accordance with an example embodiment;

FIG. 4 is a diagrammatic representation of an example user profile section, in accordance with an example embodiment;

FIG. 5 is a diagrammatic representation of an example user interface to generate an electronic invitation, in accordance with an example embodiment;

FIG. 6 is a diagrammatic representation of an example data structure to represent electronic invitation information, in accordance with an example embodiment;

FIG. 7 is a diagrammatic representation of an example data structure to represent electronic bookmark information, in accordance with an example embodiment; and

FIG. 8 is a diagrammatic representation of an example machine in the form of a computer system within which a set of instructions, for causing the machine to perform any one or more of the methodologies discussed herein, may be executed.

### DETAILED DESCRIPTION

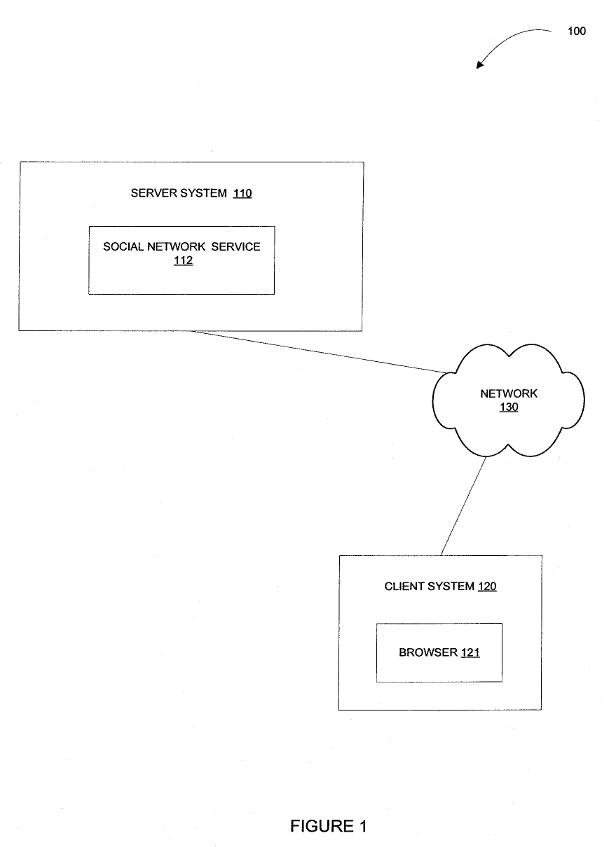

A system and method are described to integrate an electronic invitation process with an online social network user interface. In one example embodiment, an electronic invitation process may be invoked directly from a member profile section of the online social network user interface. Example embodiments of a system to integrate an electronic invitation process with an online social network user interface may be implemented in the context of a network environment. An example of such a network may be described with reference to FIG. 1.

FIG. 1 illustrates a network environment 100. The environment 100, in an example embodiment, includes a server system (server) 110 and a client system (client) 120, coupled to a communications network 130. The communications network 130 may be a public network (e.g., the Internet, a wireless network, etc.) or a private network (e.g., LAN, WAN, Intranet, etc.). In the environment 100, the server 110 may host an online social network service 112. The client 120 may have access to the online social network service 112 via a browser application 121.

The online social network service 112, in one example embodiment, may be designed to permit a user to access a home webpage that may provide information about the service and instructions describing how a user may become a member of the online social network. For the purposes of this description, the term member will be understood to include any individual who has registered with the online social network service 112 or has otherwise been granted access to the functionality of the online social network service 112. In one example embodiment, a member may be permitted to access, free of charge, some or all of the functionality provided by the online social network service 112. In some example embodiments, members may be provided with access to additional functionality of the online social network service 112 for a predetermined fee. In yet another example embodiment, a member may be required to pay a fee in order to access any of the functionality provided by the online social network service 112.

A social network facilitated by the online social network service 112 may be an open social network, such that a member may be permitted to add other members as contacts to their preferred contacts list. The contacts may then be organized utilizing interest groups that each member may create individually. Various interest groups may include, e.g., a yoga group, a book club group, etc. Members may send electronic invitations to everyone in a particular interest group by indicating that all contacts in the interest group are to be included in the invitee list of an electronic invitation. In one example embodiment, a member may search or browse through member profile pages presented by the online social network service 112 and add selected members to the invitee list of an electronic invitation.

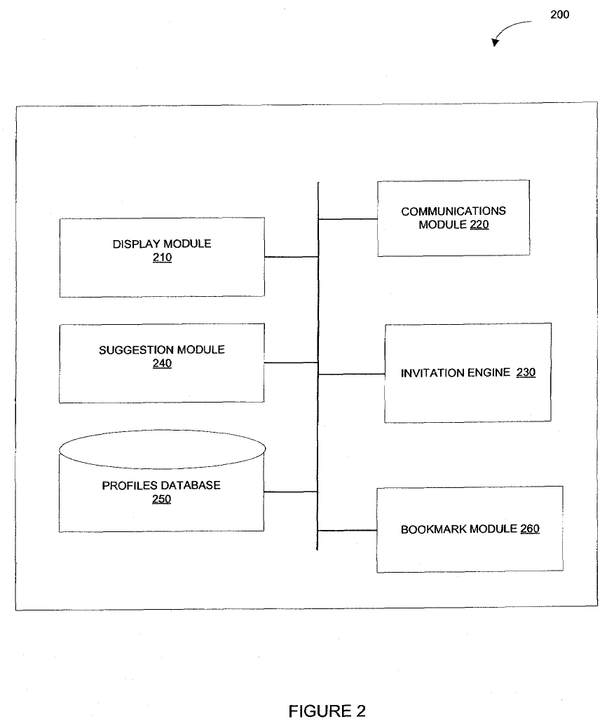

In one example embodiment, the online social network service 112 may be used by members to maintain their profile information, access other members' profiles, create categories, group other members' information, as well as plan social events and create invitations for the social events. The online social network service 112, in one example embodiment, may include one or more modules to permit users to utilize an electronic invitation process. An example online social network service that includes one or more integrated electronic invitation modules is discussed below with reference to FIG. 2.

FIG. 2 is a block diagram of a system 200 to generate an electronic invitation. The system 200 may include an integrated suite of components to provide electronic invitation capability to users, e.g., to members of the online social network service 112. As shown in FIG. 2, the system 200 includes a display module 210, a communications module 220, and an invitation engine 230. The display module 210, in one example embodiment, may be configured to display a member profile section and one or more of associated controls, such as an invite control and a bookmark control. The member profile section and the one or more of associated controls may be displayed via a web page associated with the online social network service 112. The communications module 220 may be configured to receive requests from members of the online social network service 112.

In one example embodiment, the communications module 220 may be configured to detect that a user has activated a control (e.g., a control button) provided via a webpage associated with the online social network service 112. The communications module 220 may then determine an identification of the control, and provide this information to an associated functional module that may then process the associated request as appropriate. For example, a user may click on an “INVITE” control button, the communications module 220 may detect that the “INVITE” control button has been engaged and pass control to the invitation engine 230.

Thus, when the communications module 220 detects a request associated with “INVITE” control button, the system 200 activates the invitation engine 230. The invitation engine 230, in one example embodiment, may be configured to cooperate with the display module 210, so that the display module 210 may display an invitation workspace in response to a user activating the “INVITE” control button. It will be noted, that an example invitation workspace may be implemented and presented to a user utilizing a variety of techniques, as would be understood by a person skilled in the art.

The invitation engine 230 may then add associated member information to a guest list portion of the invitation workspace. In addition to displaying the invitation workspace, the display module 210 may also display a viewable section that may include identification controls for some or all of the members of the online social network service 112. Such viewable section may be referred to as a members panel. The communications module 220, in one example embodiment, may detect events associated with the user clicking on an identification control in the members panel and cause the invitation engine 230 to add associated information to the guest list displayed on the invitation workspace.

The system 200 to generate an electronic invitation may further include a suggestion module 240. The suggestion module 240 may be configured to detect an indication of an invitation process, parse the information associated with the members of the online social network service 112, and identify candidate invitees according to some predetermined criteria.

In one example embodiment, the suggestion module 240 may be configured to detect attribute or characteristics of the event to which the invitation relates, and suggest a candidate based on the event attributes or characteristics. Example characteristics associated with an event may include, for example, event type, event location, event time, and event duration. For example, where the event is a wine tasting event, a matching operation may be performed to identify members that have indicated an interest in wine. Another example may include suggesting as potential invitees only those members who reside or work in certain proximity to the location of the subject event.

The information associated with the members of the online social network service 112 may be stored, in one example embodiment, in a profiles database 250. The profiles database 250, in one example embodiment, may include information such as demographic information associated with a member, member's preferences, etc. It will be noted, that the profiles database 250 may reside locally with respect to the system 200 or, in some embodiments, the profiles database 250 may reside at a location that is accessible by the system 200 via a network.

The suggestion module 240 may be configured to provide a suggestion to the user to include the identified candidate invitees in the guest list displayed in the invitation workspace. In some example embodiments, the suggestion module 240 may be configured to automatically include identification information associated with the identified candidate invitees in the guest list displayed in the invitation workspace.

As mentioned above, the suggestion module 240 may be configured to identify candidate invitees according to certain criteria. The criteria utilized by the suggestion module 240 may be associated with a contact status of a particular member of the online social network service 112. A contact status of one member with respect to another member may be generated utilizing a bookmark module 260 of the system 200. The bookmark module 260 may be configured to detect a request from a user to identify a particular member of the online social network service 112 as a contact with respect to the user who is the originator of the request.

The suggestion module 240, in one example embodiment, may be configured to automatically detect that an invitation process has been initiated and, in response, determine any contacts with respect to the originator of the request to initiate invitation process. The suggestion module 240 may then automatically add the determined contacts to the guest list displayed in the invitation workspace.

It will be noted that, in some example embodiments, the functions performed by two separate modules of the system 200 may be performed by a single module. For example, operations to determine candidate invitees may be performed by the bookmark module 260. In another example embodiment, the operations performed by the suggestion module 240 and the bookmark module 260 may be performed by a single functional module (not shown). Conversely, operations performed by a single module of the system 200 may be performed, in one example embodiments, by multiple functional modules. Various modules of the system 200 may reside on one server system or, alternatively, may be distributed across a plurality of server systems or server and client systems.

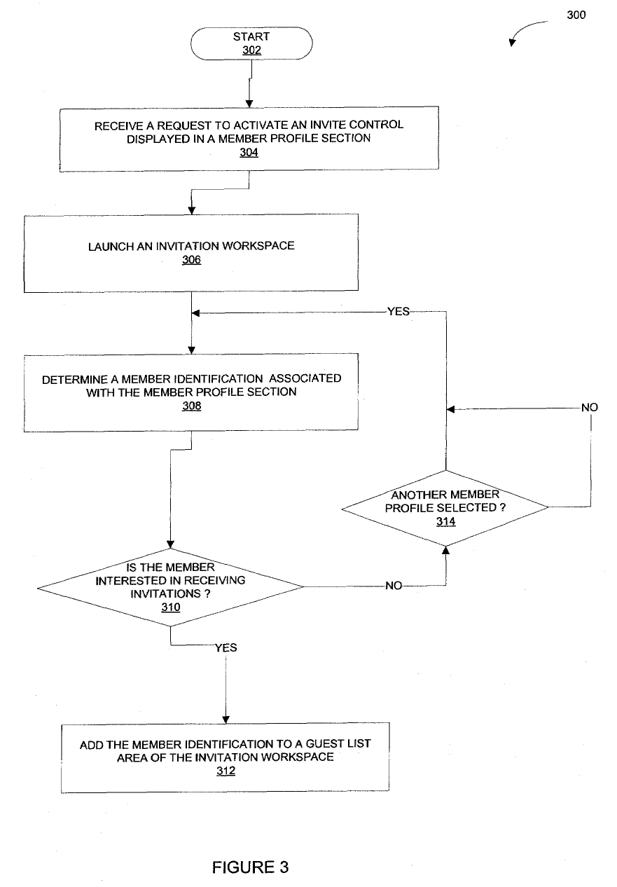

As mentioned above, the online social network service 112, which, in an example embodiment, may be implemented as the system 200, may be utilized to generate an electronic invitation and to send the electronic invitation to one or more invitees. An example method to generate an electronic invitation is described with reference to FIG. 3.

FIG. 3 is a flow chart of a method 300 to generate an electronic invitation, according to an example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at a server system 110 of FIG. 1. In another example embodiment, the processing logic may reside at the client 120 or may be distributed between the client 120 and the server 110 of FIG. 1. In one example embodiment, the method 300 may be performed by the various modules discussed above with reference to FIG. 2. Each of these modules may comprise processing logic.

As shown in FIG. 3, the method 300 commences at operation 302. At operation 304, the communications module 210 receives, from a user (e.g., a member of the online social network service 112) a request to activate an invite control. The invite control, in one example embodiment, may be viewable from a member profile section provided by the online social network service 112. The request may be associated with a request to initiate an electronic invitation process and may be triggered by clicking on an “INVITE” control button. In one example embodiment, the request to activate an invite control may be triggered by a user depressing a predetermined combination of keys on a keyboard or a keypad, or, for example, by selecting a certain graphical object in a member section included in a user interface associated with the online social network service 112.

The system 200, in one example embodiment, may react to the request to activate the invite control by causing the display module 210 to launch, at operation 306, an invitation workspace viewable by the user. The launching of the invitation workspace may be used to provide to the user with an indication that an electronic invitation process is being initiated. In one example embodiment, the invitation workspace may include a “GUEST LIST” display area.

At operation 308, the invitation engine 230 determines identification information for the member associated with the member profile section. In one example embodiment, member profile information may indicate that the associated member of the online social network service 112 does not wish to receive any invitations. Conversely, member profile information may indicate that the associated member of the online social network service 112 is interested in receiving invitations. Thus, the invitation engine 230 may be configured to react to the request to activate the invite control by determining, at operation 310, whether the member associated with the member profile section is interested in receiving invitations form other members of the online social network service 112.

If it is determined, at operation 310, that the member associated with the member profile section is interested in receiving invitations from other members of the online social network service 112, the invitation engine 230 adds the identification information for the member to the guest list viewable from the “GUEST LIST” display area at operation 312. If it is determined, at operation 310, that the member associated with the member profile section does not wish to receive invitations form other members of the online social network service 112, the invitation engine 230 passes control to the communications module 210. The communications module 210 may monitor for a user's selection of another member profile.

If it is determined, at operation 314, that the user has selected another member profile for adding the associated member identification to the invitee list or otherwise indicated a selection of a member, the method proceeds to operation 308. At operation 308, the invitation engine 230, again, determines identification information for the selected member.

The method 300 may continue until the user is satisfied with the list of invitees displayed in the “GUEST LIST” display area. The communications module 210 may be configures to receive requests from a user to finalize the invitation, to save the resulting invitation, to send the invitations to recipients utilizing the invitees list, etc.

It will be noted, that although the operations of the method 300 have been described as following a certain order, the described order of operations may be altered in some example embodiments. For example, the operation to display the invitation workspace may be performed subsequent to the operation to determine member identification information.

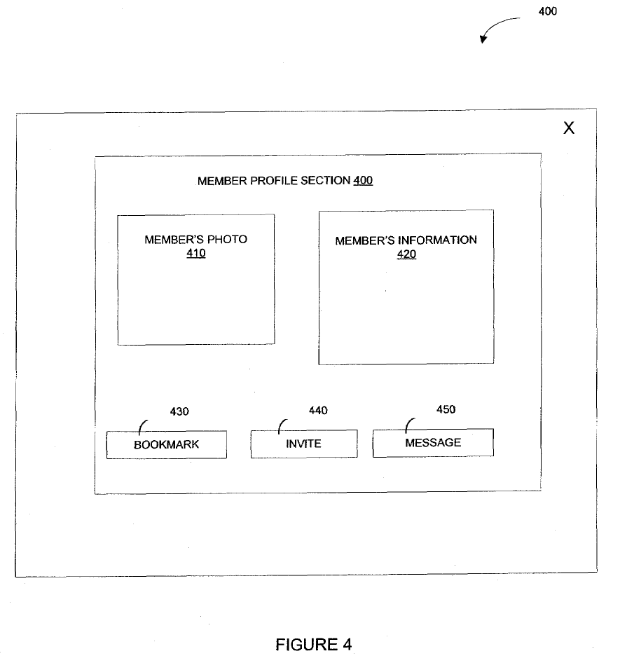

FIG. 4 is a diagrammatic representation of an example user profile section 400, in accordance with an example embodiment. In the context of the online social network service 112, the user profile section 400 may be utilized to provide a viewer with information associated with a particular member of the online social network. As shown in FIG. 400, the user profile section 400 may include a member's photo area 410, a member's information area 420, and various controls, such as, for example, control buttons and links.

The member's information area 420, in one example embodiment, may include information that describes certain characteristics of a member. Such information may include, for example, the member's name, age, education, occupation, location, etc. The member's information may be utilized by other members to search for members that are, for example, interested in specific activities. This type of filtering may also be utilized to generate an invitee list for a social event.

The controls that may be provided in the user profile section 400 may include a “BOOKMARK” button 430, an “INVITE” button 440, and a “MESSAGE” button 450. The “BOOKMARK” button 430 may be associated with the bookmark module 260 of FIG. 2. It will be noted that, in some example embodiments, all or some of the “BOOKMARK” button 430, the “INVITE” button 440, and the “MESSAGE” button 450 may be displayed outside of the member's information area 420 but viewable simultaneously with the member's information area 420.

In one example embodiment, a user may request to identify a member associated with the currently displayed member's profile as the user's contact by clicking on the “BOOKMARK” button 430. It will be noted that, for the purposes of this description, the term “contact,” when used with respect to a user, will be understood to include those members that have been selected by the user, e.g., via activation the “BOOKMARK” button 430. The contacts created with the use of the bookmark module 260 and the “BOOKMARK” button 430, in one example embodiment, may be further sorted and categorized. The “MESSAGE” button 450 may be used to initiate an electronic message process, e.g., to send a message to a member associated with the member's profile.

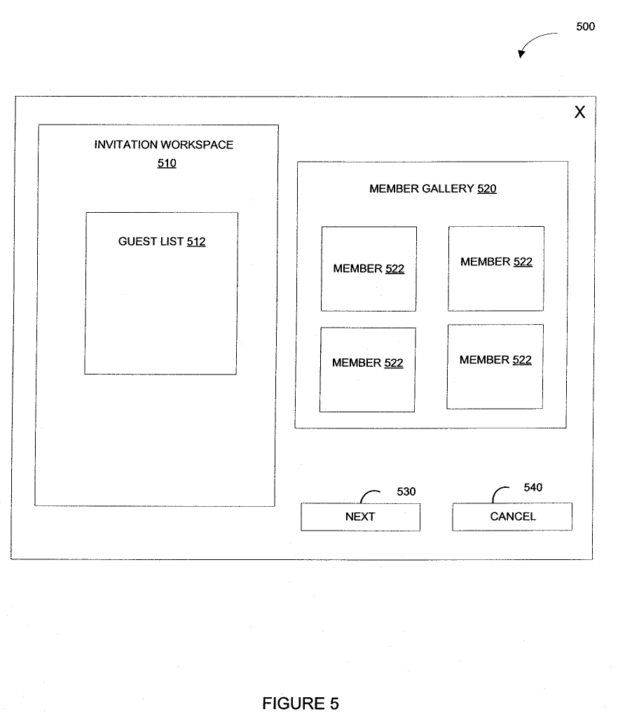

As mentioned above, the “INVITE” button 440 may be used to initiate an electronic invitation process and to cause the display module 210 to display an invitation workspace. An example user interface (UI) to generate an electronic invitation may be described with reference to FIG. 5.

FIG. 5 is a diagrammatic representation of an example UI 500 to generate an electronic invitation. The user interface 500, in accordance with an example embodiment, may comprise an “INVITATION WORKSPACE” 510 that may be used to display a “GUEST LIST” 512. A user may add an invitee to the “GUEST LIST” 512 by selecting a member from a “MEMBER GALLERY” 420. The “MEMBER GALLERY” 420 may include “MEMBER” items 422. In one example embodiment, if a user selects “MEMBER” items 422, an identification of an associated member may be added to the “GUEST LIST” 512.

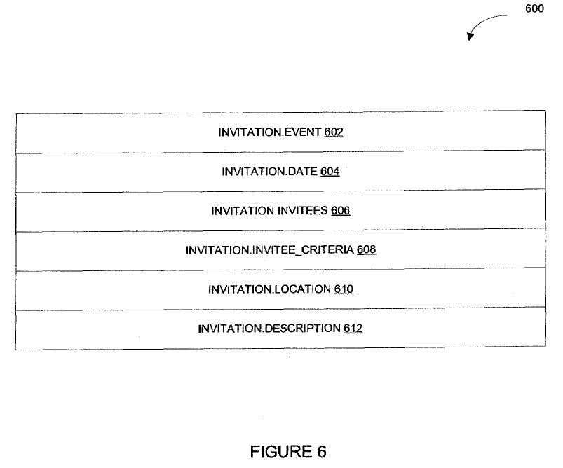

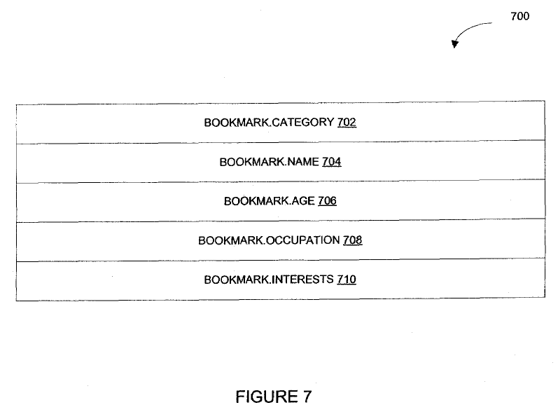

In one example embodiment, the user interface 500 may include a “CANCEL” control 530 that can be used to exit the user interface 500 without saving any of the electronic invitation information. The user interface 500 may also include a “NEXT” control 540 that may be used to complete the process of generating an electronic invitation. In order to represent and manipulate information in the context of the online social network service 112, the system 200 of FIG. 2 may utilize various example data structures, as discussed with reference to FIG. 6 and FIG. 7 below.

FIG. 6 is a diagrammatic representation of an example data structure 600 to represent electronic invitation information, in accordance with an example embodiment. As shown in FIG. 6, the data structure 600 comprises fields 602 through 612. An “INVITATION.EVENT” field 602 may be used to represent the title of an event. An “INVITATION.DATE” field 604 may be used to represent the date of the event. An “INVITATION.INVITEES” field 606 may be used to represent the list of guests for the event. An “INVITATION.INVITEE_CRITERIA” field 608 may be used to represent invitee selection criteria. For example, if the event is a nature hike, the invitee selection criteria may be a member's interest in outdoor activities.

An “INVITATION.LOCATION” field 610 may be used to represent the location of the event. Finally, an “INVITATION.DESCRIPTION” field 612 may be used to represent the description of the event. It will be noted, that a data structure to represent electronic invitation information may include different or additional data fields.

FIG. 7 is a diagrammatic representation of an example data structure 700 to represent bookmark information, in accordance with an example embodiment. The term bookmark in the context of the online social network service 112 will be understood to refer to information associated with a member that has been selected as a contact with respect to another member.

As shown in FIG. 7, the data structure 700 comprises fields 702 through 710. A “BOOKMARK.CATEGORY” field 702 may be used to represent a category to which the bookmarked member may belong. For example, if a user desires to compile a list of members who may be potentially interested in attending a yoga class, the user may select (or bookmark) such users and save the list utilizing the “BOOKMARK” button 430 of FIG. 4. The “BOOKMARK.CATEGORY” field 702 may then be used to store the “Yoga” value. A “BOOKMARK.NAME” field 704 may be used to represent the name of the bookmarked member. A “BOOKMARK.AGE” field 706 may be used to represent the age of the bookmarked member.

Other fields may include a “BOOKMARK.OCCUPATION” field 708 that may be used to represent the occupation of the bookmarked member. A “BOOKMARK.INTERESTS” field 706 may be used to represent information related to the interests of the bookmarked member. It will be noted, that a data structure to represent bookmark information may include different or additional data fields.

It will be noted, that the electronic invitation information, the bookmark information, as well as other information utilized by the system 200 of FIG. 2, may be represented utilizing a variety of techniques that may be available to a person skilled in the art.

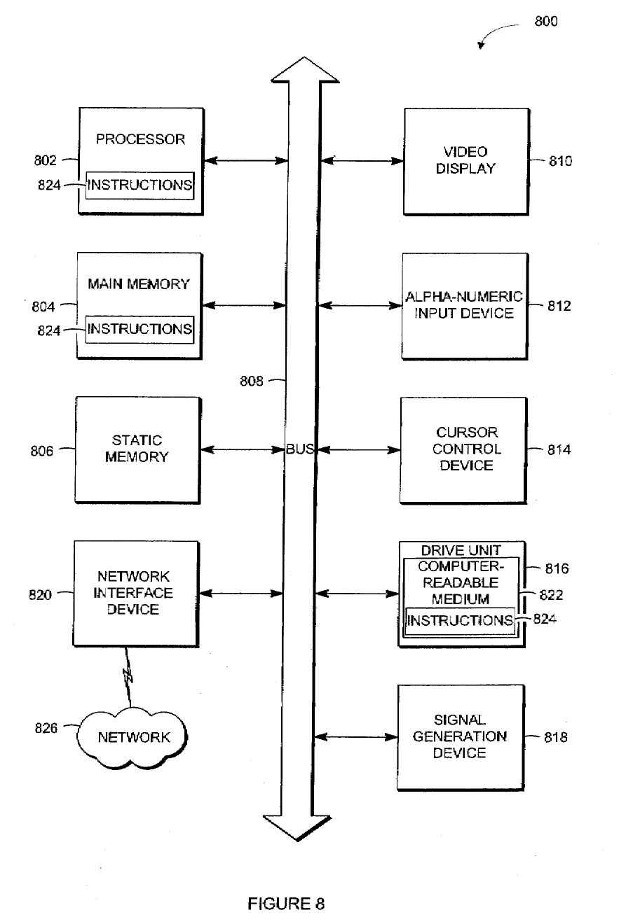

FIG. 8 shows a diagrammatic representation of a machine in the example form of a computer system 800 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as a “Moving Picture Experts (MPEG) Layer 3” (MP3) player, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alpha-numeric input device 812 (e.g., a keyboard), a user interface (UI) navigation device 814 (e.g., a cursor control device), a disk drive unit 816, a signal generation device 818 (e.g., a speaker) and a network interface device 820.

The disk drive unit 816 includes a machine-readable medium 822 on which is stored one or more sets of instructions and data structures (e.g., software 824) embodying or utilized by any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media.

The software 824 may further be transmitted or received over a network 826 via the network interface device 820 utilizing any one of a number of well-known transfer protocols (e.g., Hyper Text Transfer Protocol (HTTP)).

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of embodiments of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware.

Thus, a method and system to generate an electronic invitation have been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A system comprising:
a display module to display an invite control, the invite control viewable from a member profile section, the member profile section to display a profile of a member;
a communications module to receive a request to activate the invite control; and
an invitation engine to react to the request by adding an identification of the member to an invitee list.

2. The system of claim 1, wherein the invitation engine is to initiate an electronic invitation process in response to the request to activate the invite control.

3. The system of claim 1, wherein the display module is to display an invitation workspace in response to the request to activate the invite control.

4. The system of claim 1, wherein the invitation engine is to generate an electronic invitation utilizing the invitee list.

5. The system of claim 1, wherein the invite control and the profile of the member are associated with an online social network service.

6. The system of claim 5, wherein:
the communications module is to receive the request to activate the invite control from an originator, the originator being a member of the online social network service; and
the member is a member of the online social network service.

7. The system of claim 5, further comprising a suggestion module to:
detect information associated with a candidate, the candidate being a member of the online social network service; and
selectively, based on a parameter, generate a suggestion to add an identification of the candidate to the invitee list.

8. The system of claim 7, wherein the parameter is association information for the member and the candidate.

9. The system of claim 5, further comprising a suggestion module to:
detect an attribute of an event associated with the guest list;
detect information associated with a candidate, the candidate being a member of the online social network service; and
selectively, based on the attribute of the event and on the information associated with the candidate, generate a suggestion to add an identification of the candidate to the invitee list.

10. The system of claim 1, further comprising a bookmark module, wherein:
the display module is to display a bookmark control viewable from the member profile section;
the communications module is to receive a request to activate the bookmark control; and
the bookmark module is to respond to the request to activate the bookmark control by identifying the member as a contact of an originator of the request to activate the bookmark control.

11. The system of claim 1, wherein the invitation engine is to:
detect a contact associated with an originator of the request to activate the invite control; and
add an identification of the contact to the invitee list.

12. A computer-implemented method, the method comprising:
displaying an invite control, the invite control viewable simultaneously with a member profile section, the member profile section to display a profile of a member;
receiving a request to activate the invite control; and
reacting to the request by adding an identification of the member to an invitee list.

13. The method of claim 12, wherein the reacting to the request comprises initiating an electronic invitation process.

14. The method of claim 12, wherein the adding of the member's information to the invitee list comprises displaying an invitation workspace.

15. The method of claim 12, further comprising generating an electronic invitation utilizing the invitee list.

16. The method of claim 12, wherein the invite control and the profile of the member are associated with an online social network service.

17. The method of claim 16, wherein:
an originator of the request to activate the invite control is a member of the online social network service; and
the member is a member of the online social network service.

18. The method of claim 16, further comprising:
detecting information associated with a candidate, the candidate being a member of the online social network service; and
selectively, based on a parameter, generating a suggestion to add an identification of the candidate to the invitee list.

19. The method of claim 18, wherein the parameter is association information for the member and the candidate.

20. The method of claim 16, further comprising:
detecting an attribute of an event associated with the guest list;
detecting information associated with a candidate, the candidate being a member of the online social network service; and
selectively, based on the attribute of the event and on the information associated with the candidate, generating a suggestion to add an identification of the candidate to the invitee list.

21. The method of claim 12, further comprising:
displaying a bookmark control viewable from the member profile section;
receiving a request to activate the bookmark control; and
responding to the request to activate the bookmark control by identifying the member as a contact of an originator of the request to activate the bookmark control.

22. The method of claim 12, further comprising:
detecting a contact associated with the originator of the request to activate the invite control; and
adding an identification of the contact to the invitee list.

23. A method comprising:
invoking an electronic invitation process responsive to activation of a control viewable with a member profile section;
automatically identifying invitees based on profiles of online social network members; and
adding the identified invitees into an electronic invitation associated with the electronic invitation process.

24. A method comprising:
initiating an electronic invitation process to an event response to a request received from a first user; and
automatically identifying a second user to be suggested as an invitee to the event using event characteristic information associated with the event.

25. The method of claim 24, wherein the event characteristic information is selected from a group of event characteristic information items including event type, event location, event time, and event duration.

26. The method of claim 24, wherein the identifying of the second user to be suggested as an invitee to the event comprises using profile information of the first user.

27. The method of claim 26, wherein the profile information is selected from a group of profile information items including user demographic information and user preference information.

28. The method of claim 24, wherein the automatic identification of the second user includes performing a matching operation between the characteristic information associated with the event and user profile information of the second user.

29. A machine-readable medium having instruction data to cause a machine to:
display an invite control, the invite control viewable from a member profile section, the member profile section to display a profile of a member;
receive a request to activate the invite control; and
react to the request by adding an identification of the member to an invitee list.

30. An apparatus comprising:
means for displaying an invite control, the invite control viewable from a member profile section, the member profile section to display a profile of a member;
means for receiving a request to activate the invite control; and
means for reacting to the request by adding an identification of the member to an invitee list.

31. A graphical user interface comprising:
a member profile section to display a profile of a member;
an invitation workspace to display a guest list; and
an invite control, the invite control viewable simultaneously with the member profile section, the invite control to trigger an activation of the invitation workspace in response to a request to activate the invite control.

32. The graphical user interface of claim 24, wherein the invitation workspace is viewable simultaneously with a plurality of graphical items, the plurality of graphical items being associated with a plurality of members of an online social network service.
